(19) United States
(12) Patent Application Publication
(10) Pub. No.: US 2020/0039384 A1
(43) Pub. Date: Feb. 6, 2020

(54) VEHICLE

(71) Applicant: HONDA MOTOR CO., LTD., Tokyo (JP)

(72) Inventor: Yuki TAKAMURA, Wako-shi (JP)

(21) Appl. No.: 16/505,035

(22) Filed: Jul. 8, 2019

(30) Foreign Application Priority Data
Aug. 6, 2018 (JP) 2018147503

(51) Int. Cl. B60N 2/01; B60N 3/00; B60R 21/02; B60R 11/02

(52) U.S. Cl. CPC B60N 2/01; B60N 3/002; B62D 47/00; B60R 11/0235; B60R 21/026

(57) ABSTRACT

A vehicle includes multiple seats arranged in a fore and aft direction in a cabin of the vehicle. Each of the multiple seats are disposed to face obliquely forward such that the seats are parallel to one another, and a partition wall is provided between each adjoining pair of seats.

### TECHNICAL FIELD

The present invention relates to a vehicle, and in particular to a vehicle with a novel seat arrangement.

### BACKGROUND ART

In an autonomous vehicle, the driver is not required to be facing forward at all times, and therefore, the front seat may be selectively turned rearward so as to face the rear seat. See JP2017-039400A, for instance. Thus, the introduction of autonomous vehicles has created new possibilities for seat arrangement.

Also, ride share is receiving a growing attention from the view point of reducing traffic congestion and CO₂ emission. In a ride share, groups of people sharing common destinations share common vehicles. Oftentimes, people sharing a ride may be strangers to one another. Therefore, in addition to securing as large a space as possible for each passenger, some consideration may be desired in seating the people sharing the ride so as to maximize privacy and minimize stress. On the other hand, people sharing the ride may know one another. In such a case, it may be desired that the passengers are seated so as to facilitate mutual conversation.

### SUMMARY OF THE INVENTION

In view of such a background of the prior art, a primary object of the present invention is to provide a vehicle that can secure a large space for each passenger and can provide a comfortable cabin space to minimize stress of the passengers even when the passengers of the vehicle are not specified (and hence the passengers may be strangers to one another).

To achieve such an object, one embodiment of the present invention provides a vehicle (1) comprising a plurality of seats (30) arranged in a fore and aft direction in a cabin (5) of the vehicle, wherein each seat is disposed to face obliquely forward such that the seats are in parallel with one another, and a partition wall (34) is provided between each adjoining pair of the seats.

The vehicle having the above structure can secure a large space for each passenger and can provide a comfortable cabin space to minimize stress of the passengers even when the passengers of the vehicle are not specified.

In the above vehicle (1), preferably, the seats (30) are arranged to face one of left and right sides of the cabin (5), a passage (33) is provided in the cabin to extend in the fore and aft direction along the one of the left and right sides of the cabin, and a door opening (21) is provided in a side wall (13) of the vehicle (1) on a side on which the passage (33) is provided.

According to this configuration, the passengers are allowed to go to their respective seats (30) from the door opening (21) by walking through the passage (33).

In the above vehicle (1), preferably, each partition wall (34) is disposed on a lateral side of a seat cushion (31) and a seat back (32) of an associated seat (30) and extends in parallel with the seat (30).

According to this configuration, the seats (30) can be partitioned from one another without creating a dead space.

In the above vehicle (1), preferably, each partition wall (34) is provided with a movable wall (37) that can be opened and closed.

According to this configuration, a state for securing privacy and a state for allowing the passengers to enjoy conversation can be selected by changing the position of the movable wall.

In the above vehicle (1), preferably, the movable wall (37) is provided at a height corresponding to an upper end of the seat back (32) of the associated seat (30).

According to this configuration, it can be ensured that passengers seated on adjoining seats (30) cannot see each other's face, so that privacy is maintained.

In the above vehicle (1), preferably, each partition wall (34) is provided with a liquid crystal panel (43) that can be switched between transparent and opaque states.

According to this configuration, a state for securing privacy and a state for allowing the passengers to enjoy conversation can be selected by varying the state of the liquid crystal panel.

In the above vehicle (1), preferably, each partition wall (34) extends rearward of the associated seat back, such that storage spaces (38) separated by the partition walls (34) are defined on the rear side of the respective seat backs.

According to this configuration, highly secure storage spaces (38) can be obtained.

In the above vehicle (1), preferably, each partition wall (34) is provided with a table (40) that can be stowed and deployed.

According to this configuration, by stowing the table (40), it is possible to prevent the table (40) from interfering with the passenger when the passenger sits on the seat 30 or the like.

Thus, the vehicle according to an embodiment of the present invention can secure a large space for each passenger and can provide a comfortable cabin space to minimize stress of the passengers even when the passengers of the vehicle are not specified.

### BRIEF DESCRIPTION OF THE DRAWINGS

FIG. 1 is perspective view of a vehicle according to a first embodiment of the present invention as viewed from an upper left direction;

FIG. 2 is a left side view of the vehicle;

FIG. 3 is a right side view of the vehicle;

FIG. 4 is a plan view of a cabin of the vehicle;

FIG. 5 is a diagram showing the cabin as viewed approximately in the forward direction of the vehicle;

FIG. 6 is a partial perspective view showing a seat and a partition wall of the vehicle; and

FIGS. 7A to 7C are diagrams showing a seat and a partition wall of a vehicle according to a second embodiment as viewed approximately in the forward direction of the vehicle.

### DESCRIPTION OF THE PREFERRED EMBODIMENT(S)

Preferred embodiments of a vehicle according to the present invention are described in the following with reference to the appended drawings.

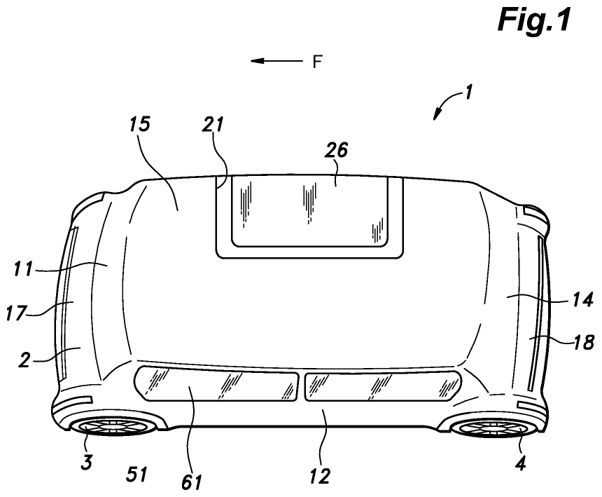

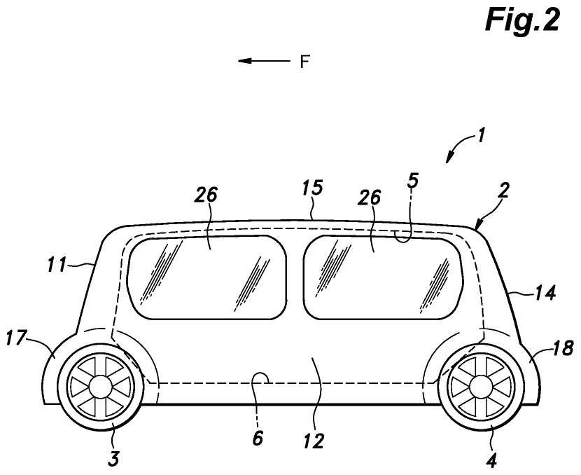

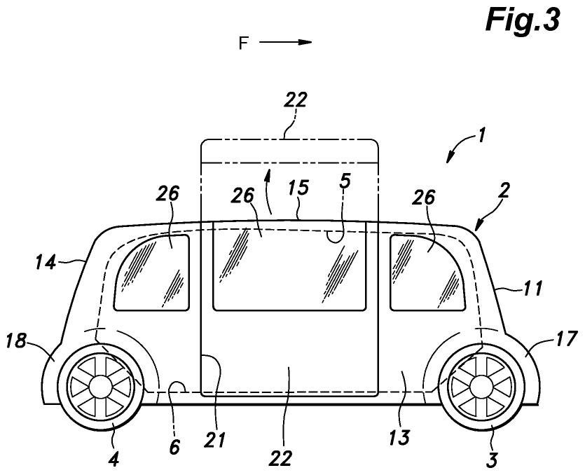

As shown in FIGS. 1 to 3, a vehicle 1 according to a first embodiment of the present invention consists of a four-wheeled vehicle (automobile). The vehicle 1 has a substantially rectangular vehicle body 2 elongated in the fore and aft direction. The vehicle body 2 is provided with a pair of front wheels 3 and a pair of rear wheels 4. The vehicle 1 may consist of an autonomous vehicle that does not require a driver.

As shown in FIGS. 1 to 4, a central part of the vehicle body 2 defines a substantially rectangular cabin 5 which is elongated in the fore and aft direction. The cabin 5 is defined by a floor 6, a front wall 11 extending laterally and vertically along a front edge of the floor 6, a left wall 12 extending rearward from the left edge of the front wall 11, a right wall 13 extending rearward from the right edge of the front wall 11, a rear wall 14 extending between the rear edges of the left wall 12 and the right wall 13, and a roof 15 connected to the upper edges of the front wall 11, the left wall 12, the right wall 13 and the rear wall 14.

A drive source for traveling such as an electric motor and an internal combustion engine, and a control unit such as an ECU are mounted either in a front part 17 of the vehicle body 2 located ahead of the front wall 11 or in a rear part 18 of the vehicle body 2 located behind the rear wall 14. The remaining available space in the vehicle front part 17 and the vehicle rear part 18 may be used as a luggage stowage space.

The right wall 13 is provided with a door opening 21 which is fitted with a door 22 for selectively closing the door opening 21. The door opening 21 extends from the lower end of the right wall 13 to a middle part of the roof 15. The door 22 in this embodiment consists of a gull-wing door, and is supported by the roof 15 at an upper end so as to be rotatable about a rotational axis (not shown in the drawings) extending in the fore and aft direction. Alternatively, the door 22 may consist of a regular swing door or a slide door. Windows 26 each fitted with a glass pane are provided in the remaining parts of the right wall 13 located ahead of and behind the door 22, in an upper part of the door 22, and in a large part of the left wall 12. For example, the vehicle 1 can be used as a means of transportation in a shopping mall, between terminals of an airport, or between a terminal and an airplane at an airport.

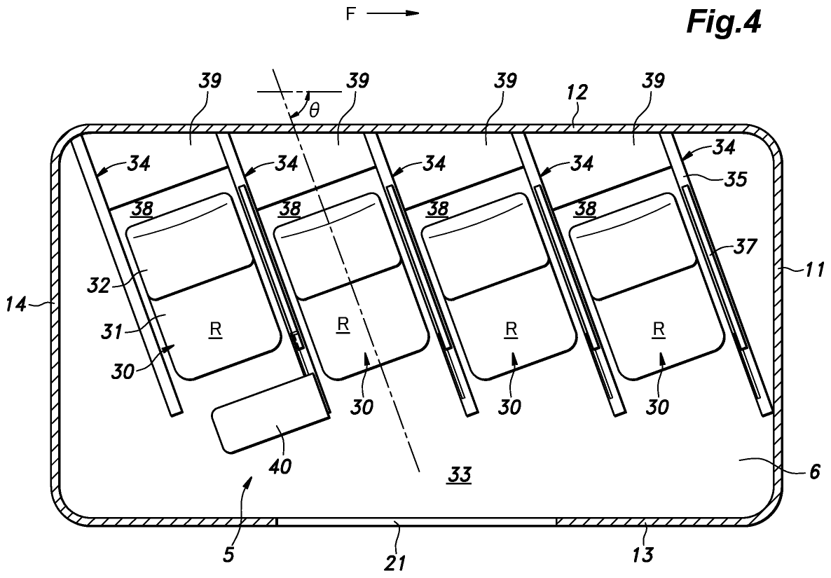

As shown in FIG. 4, multiple seats 30 are disposed on the floor 6 of the cabin 5 so as to be arranged in the fore and aft direction of the vehicle 1. Each seat 30 includes a seat cushion 31 and a seat back 32 connected to one end of the seat cushion 31. The end of the seat cushion 31 to which the seat back 32 is connected may be referred to as a base end or rear end of the seat cushion 31, and the end of the seat cushion 31 opposite to the base end may be referred to as a front end of the seat cushion 31. Also, the side of each seat 30 on which the front end of the seat cushion 31 is located may be referred to as a front side of the seat 30.

Each seat 30 is arranged to face the right wall 13 in which the door opening 21 is provided. Namely, the seat cushion 31 of each seat 30 is positioned closer to the right wall 13 than the seat back 32 of the same is.

Each seat 30 is disposed to face obliquely forward with respect to the vehicle 1 such that the seats 30 are in parallel with one another in plan view. Specifically, each seat 30 is inclined laterally at an inclination angle θ relative to the fore and aft direction of the cabin 5 in plan view such that the front side of the seat 30 is positioned more forward than the rear side of the seat 30 with respect to the traveling direction of the vehicle 1 and the seats 30 are in parallel with one another. The inclination angle θ is an angle not equal to 90 degrees, and may be about 60 to 80 degrees, for example.

On one of the left and right sides of the cabin 5 that each seat 30 faces (in the illustrated embodiment, the right side of the cabin 5 on which the right wall 13 having the door opening 21 is provided), a passage 33 is provided to extend in the fore and aft direction of the cabin 5 in front of the seats 30. Thereby, the passengers can move to their respective seats 30 from the door opening 21 and also can move between the seats 30 through the passage 33.

A partition wall 34 standing upright from the floor 6 is provided between each adjoining seats 30. In the illustrated embodiment, two additional partition walls 34 are further provided on outer sides of the front and rear end seats 30, respectively. Each partition wall 34 is constituted of a flat panel and is disposed on a lateral side of the seat cushion 31 and the seat back 32 of the seat 30 associated therewith and extends in parallel with the seat 30. It is to be noted here that either of the seats 30 separated by a partition wall 34 can be considered the seat 30 associated with the partition wall 34. Thereby, the partition walls 34 separate the cabin 5 excluding the passage 33 into spaces for disposing the respective seats 30 therein, such that each space having the seat 30 disposed therein forms a semi-private compartment. This semi-private compartment may be also referred to as a one-person compartment R.

Because each partition wall 34 is disposed on the lateral side of the seat cushion 31 and the seat back 32 of the associated seat 30 and extends in parallel with the seat 30, the seats 30 are partitioned from one another without creating a dead space on the lateral sides of seats 30.

Since each seat 30 is disposed in the corresponding one-person compartment R, privacy of the passenger seated on each seat 30 can be ensured. Further, the passenger seated on one seat 30 is less disturbed by the passenger seated on the adjoining seat 30, and therefore, even when the passengers of the vehicle 1 are not specified (or the passengers are strangers to one another), stress of the passengers can be minimized. Thus, a comfortable cabin space can be obtained.

Each seat 30 is disposed to face obliquely forward at the inclination angle θ in plan view, and therefore, compared to a case where the seats 30 are arranged to face 90 degrees relative to the fore and aft direction of the cabin 5, each one-person compartment R is provided with a larger longitudinal length so that the space of each one-person compartment R is widened. This also contributes to realizing a comfortable cabin space in the vehicle 1.

Further, because each seat 30 is disposed to face obliquely forward, the passenger seated on each seat 30 also faces obliquely forward. Therefore, compared to a case where the passengers seated on the seats 30 face obliquely rearward when the vehicle 1 travels forward, passengers feel less discomfort and are less likely to suffer from car sickness.

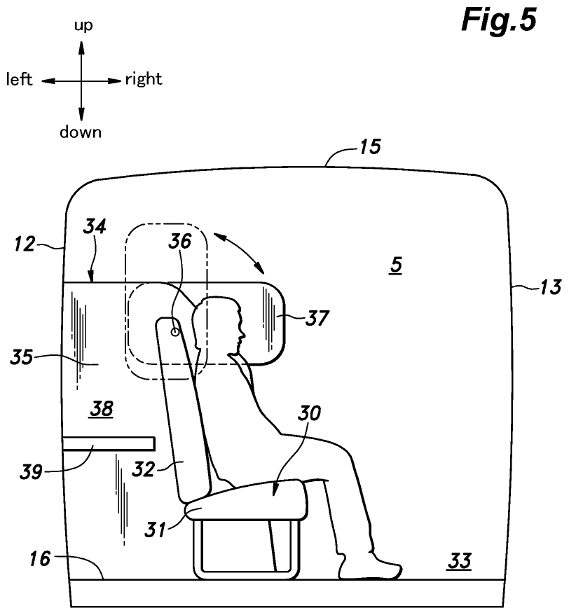

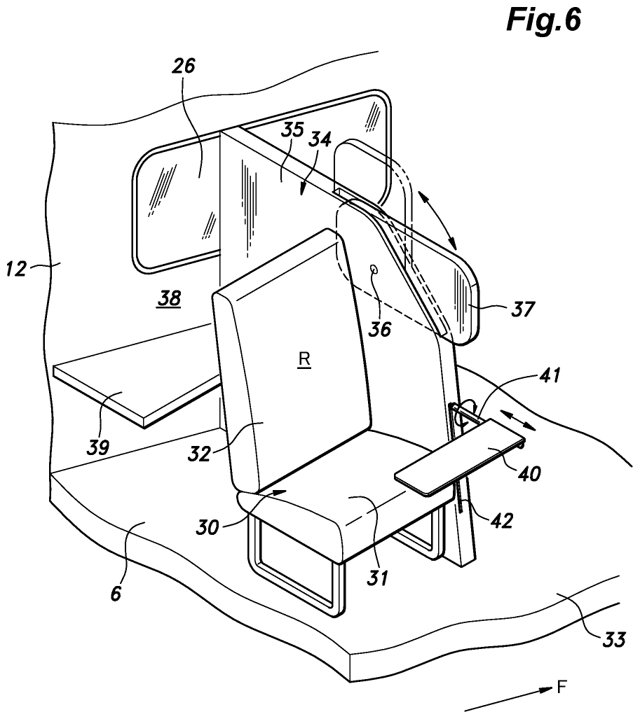

As shown in FIGS. 5 and 6, each partition wall 34 except for the one disposed on the right side of the rear end seat 30 includes a main part 35 fixed on the floor 6 and a movable wall 37 pivotably mounted on the main part 35 via a pivot shaft 36 extending in the thickness direction of the main part 35. The movable wall 37 is provided at a height corresponding to an upper end of the seat back 32 of the seat 30, and is configured to be pivotable in a plane parallel to the principal surface of the main part 5 between a horizontal position (closed position) in which the movable wall 37 protrudes from the outer edge of the main part 35 toward the passage 33 as shown by a solid line and a vertical position (open position) which is a position rotated upward by 90 degrees from the horizontal position and in which the movable wall 37 protrudes upward from the outer edge of the main part 35 as shown by an imaginary line. In the illustrated embodiment, when the movable wall 37 is in the horizontal position, the upper edge of the movable 37 is flush with the upper edge of the main part 35.

When the movable wall 37 of one partition wall 34 is in the horizontal position, the passengers seated on the seats 30 adjoining each other via the partition wall 34 are prevented from seeing each other's face or catching each other's gaze, and therefore, privacy can be maintained and an awkward situation can be avoided. On the other hand, when the movable wall 37 is in the vertical position, the passengers seated on the adjoining seats 30 can see each other's face and enjoy conversation.

The main part 35 of each partition wall 34 extends rearward of the seat back 32 of the associated seat 30 to the left wall 12 of the vehicle body 2. Thereby, storage spaces 38 separated by the main parts 35 to correspond to the respective seats 30 are defined on the rear side of the respective seat backs 32. A shelf 39 for placing a bag or the like is disposed in each storage space 38.

Because the storage spaces 38 for the respective seats 30 are provided on the rear side of the respective seats 30 and are separated from one another by the main parts 35, the storage spaces 38 are highly secure.

As shown in FIG. 6, a table 40 is provided for each seat 30. Each table 40 is mounted to the main part 35 of the associated partition wall 34 via a support bar 41, such that the table 40 is movable, by a rotation of the support bar 41 about a central axis thereof (by 90 degrees) and an axial movement of the support bar 41, between a deployed position in which the table 40 is positioned horizontally in front of the seat 30 and a stowed position in which the table 40 is stowed in a slit 42 formed in an end face of the main part 35.

When the table 40 is in the deployed position, the table 40 can be used conveniently to place a portable electronic device, a beverage, etc. thereon. When the table 40 is in the stowed position, the table 40 is prevented from interfering with the passenger when the passenger sits on the seat 30 or the like.

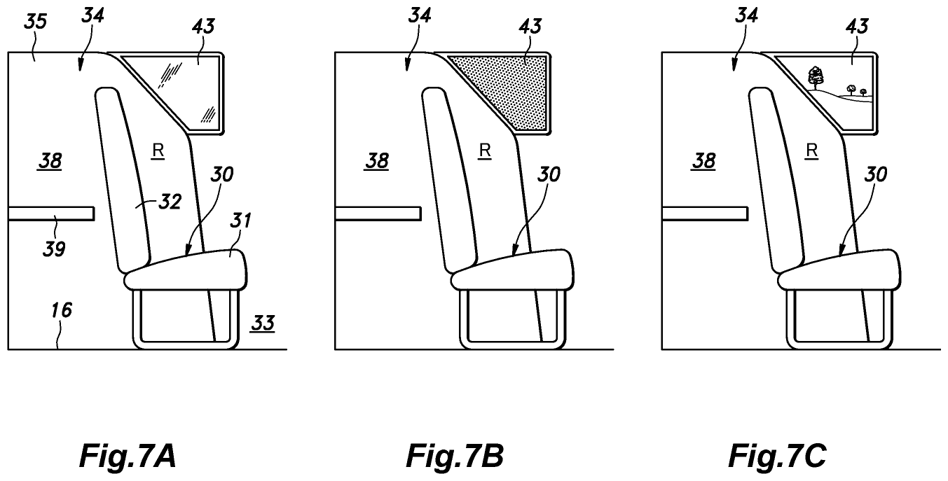

FIG. 7 shows a second embodiment of the present invention. In this embodiment, a liquid crystal panel 43 is mounted to the main part 35 of each partition wall 34 in place of the movable wall 37. Each liquid crystal panel 43 is attached to the slanted front edge of the main part 35 of the corresponding partition wall 34 such that the upper edge of the liquid crystal panel 43 is flush with the upper edge of the main part 35. Thus, the liquid crystal panel 43 projects forward from the front edge of the main part 35 at a height corresponding to the upper end of the seat back 32 (or the head of the passenger seated on the seat 30). The liquid crystal panel 43 can be switched between a transparent state in which light can pass through the liquid crystal panel 43 as shown in FIG. 7A and an opaque state in which light does not pass through the liquid crystal panel 43 as shown in FIG. 7B.

In another embodiment, the liquid crystal panel 43 may be provided in addition to the movable wall 37. In such a case, each liquid crystal panel 43 may be attached to the main part 35 of the corresponding partition wall 34 so as to substantially coincide or overlap with the protruding part of the movable wall 37 in the horizontal position.

When the liquid crystal panel 43 of one partition wall 34 is in the opaque state, the passengers seated on the seats 30 adjoining each other via the partition wall 34 are prevented from seeing each other's face or catching each other's gaze, and therefore, privacy can be maintained and an awkward situation can be avoided. On the other hand, when the liquid crystal panel 43 is in the transparent state (and the movable wall 37 is in the vertical position in the case where the movable wall 37 is provided in addition to the liquid crystal panel 43), the passengers seated on the adjoining seats 30 can see each other's face through the liquid crystal panel 43 and enjoy conversation.

As a modification, when the liquid crystal panel 43 is in the opaque state, the liquid crystal panel 43 may display an image of landscape or the like as shown in FIG. 7C.

In the foregoing, the present invention has been described in terms of preferred embodiments thereof, but the present invention is not limited to these embodiments, and may be modified appropriately within the scope of the present invention. For instance, the partition wall as a whole may be of a bellows type so as to be capable of being opened and closed. The vehicle according to the present invention is not limited to an autonomous vehicle, and may be a vehicle driven by a driver, a campervan, or a trailer that can be hitched to a tractor or any other pulling vehicle. Also, not all of the component parts shown in the foregoing embodiments are necessarily indispensable, and they may be selectively used as appropriate without departing from the scope of the present invention.

1. A vehicle comprising a plurality of seats arranged in a fore and aft direction in a cabin of the vehicle, wherein each seat is disposed to face obliquely forward such that the seats are in parallel with one another, and
a partition wall is provided between each adjoining pair of the seats.

2. The vehicle according to claim 1, wherein the seats are arranged to face one of a left and right side of the cabin,
a passage is provided in the cabin to extend in the fore and aft direction along the one of the left and right sides of the cabin, and
a door opening is provided in a side wall of the vehicle on a side on which the passage is provided.

3. The vehicle according to claim 1, wherein each partition wall is disposed on a lateral side of a seat cushion and a seat back of an associated seat and extends in parallel with the seat.

4. The vehicle according to claim 1, wherein each partition wall is provided with a movable wall that can be opened and closed.

5. The vehicle according to claim 4, wherein the movable wall is provided at a height corresponding to an upper end of a seat back of an associated seat.

6. The vehicle according to claim 1, wherein each partition wall is provided with a liquid crystal panel that can be switched between transparent and opaque states.

7. The vehicle according to claim 1, wherein each partition wall extends rearward of a seat back of an associated seat, such that storage spaces separated by the partition walls are defined on a rear side of the associated seat backs.

8. The vehicle according to claim 1, wherein each partition wall is provided with a table that can be stowed and deployed.
